(19) United States
(12) Patent Application Publication
(10) Pub. No.: US 2002/0167398 A1
(43) Pub. Date: Nov. 14, 2002

(54) Method and apparatus using the power line carrier of vehicles as a data bus

(76) Inventor: Ken Strasser, San Diego, CA (US)

Correspondence Address: J.D. Harriman II, COUDERT BROTHERS, 333 South Hope Street, 23rd Floor, Los Angeles, CA, 90071, US

(21) Appl. No.: 09/802,465

(22) Filed: Mar. 9, 2001

(51) Int. Cl. B60Q 1/00

(52) U.S. Cl. 340/425.5

(57) ABSTRACT

The invention provides a method and apparatus for using the power line carrier of vehicles as a data bus. The scope of this invention is not limited to vehicles, but can be implemented in other applications that either have a power source or wired to one. In one embodiment, the invention uses the existing power line of a HDTTU to transmit data. An electrical component is coupled to the power line and transmits detectable signals on the power line. A second electrical component is also coupled to the power line and detects and decodes the detectable signals. In one embodiment, the signals are used to generate binary words that code information. In another embodiment, the power line of a HDTTU is used to carry sensor/warning signals from sensors placed on the vehicle to a display panel on the dashboard. Sensors are coupled to a control box which is used to convert the signals to a form that can be carried on the existing power line. An existing electrical coupling connects the power line from the trailer to the cab. In the cab, a second control box is coupled to the power line and converts the detected signals to a textual display, graphical display, or audio-visual display on the dashboard. This system obviates the need for additional conductors from the trailer junction box to the cab, as well as for additional junction boxes and conductors between the cab and the trailer. This is because the present invention uses the existing power line as a carrier of data, and this existing power line runs from the front of the cab to the rear of the trailer. This simplified system that uses existing power line wires as a data bus is easier to install and more likely to be used, increasing vehicle and highway safety.

### BACKGROUND OF THE INVENTION

1. Field of the Invention

The present invention relates primarily to the field of hardware, and in particular to a method and apparatus for using the power line carrier of vehicles as a data bus.

Portions of the disclosure of this patent document contains material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

In modern times, large distances are covered effortlessly via planes, trains, ships, and a collection of ground vehicles which include cars, trucks, and vans. These vehicles have sophisticated electrical systems with an ever increasing number of electronic devices for operation, safety, environment, entertainment, communication, and even decoration. A problem is the difficulty in adding additional electronic devices and components after the manufacture of a vehicle.

One example is the addition of safety systems onto a vehicle after its manufacture. One such system is a proximity sensor system for use when backing up or maneuvering closely to obstacles. Sometimes, the driver of a ground vehicle collides with another item because the item is not visible from the driver's seat. This is particularly true for trucks and other large vehicles that extend several meters behind the driver. A rule of thumb holds that if an item is directly behind a vehicle, it must be more than three vehicle lengths away from the rear of the vehicle for the driver to be able to see it. This means that longer vehicles require the item to be further away for the driver to see it. Drivers of trucks and other large vehicles also have the added disadvantage of being seated higher up from the ground than smaller vehicles, which decreases their frontal range of vision. Small items which are directly in front of these large vehicles are invisible to the driver.

Several car makers, like BMW, have sensors attached to the rear and front bumpers of their vehicles that can detect and warn the driver about the proximity of an item. There is a beep signal that increases in frequency as the vehicle gets closer to the item letting the driver know of the closeness of a potential danger. For example, a continuous beep indicates the vehicle is about to collide with an item. This collision safety system, even though it is fundamental in avoiding collisions with objects, is factory installed only in a handful of automobiles because it is very expensive. In addition, such a system has unique problems when applied to large vehicles such as semi tractor-trailers.

Heavy Duty Tractor-trailer Unit (HDTTU)

HDTTUs (commonly referred to as 18-wheelers) are made up of two sections. The front, commonly known as the cab, is where the driver sits, and the rear, commonly known as the bed or trailer, is where the cargo sits. These two sections are coupled together for operation and can be separated for repairs, and loading and unloading of cargo. As noted above, such large vehicles have particular problems with blind spots relatively near the vehicle because of its size and the position of the driver's seat off the ground. One prior art solution is to provide an aftermarket sensor/warning system. Such a system is manufactured by Sonar Safety Systems, Inc.™, the assignee of the present application. Before describing the aftermarket sensor/warning system, a review of the wiring of a tractor-trailer unit is described in FIG. 1A.

As noted earlier, an HDTTU is comprised of two parts, and is illustrated in FIG. 1A. The driver sits in the front section, commonly known as the cab 100, and the cargo sits in the rear section, commonly known as the trailer 101. These two sections are coupled together, and can be separated for repairs, or to load and unload the cargo.

The cab section has the engine including a power source 107 and thus power and electrical generating capabilities. The trailer has electrical power requirements for lights, turn signals, back up lights, refrigeration, etc. Thus, all trailer power lines and conductors have to be wired to the cab section as well. To minimize the number of wires needed to be unplugged at the time of separation, all trailer conductors are cabled together. The power line from the power source, and other electrical conducting paths are coupled via cabling 102 to a 7-pin junction box 106 on the back of the cab 100.

A coil shaped cable 105 runs from the 7-pin junction box 106 to a 7-pin junction box 104 on the trailer side closest to the cab section. Cable 105 can be disconnected from the junction box at the trailer end when the cab 100 is uncoupled from the trailer 101. Power line 103 runs to the back of the trailer to supply power for rear lights, refrigeration, and other power needs of the trailer. Most cab/trailer combinations have this wiring and connection scheme built in at the factory.

The requirements of installing an aftermarket sensor/warning system are illustrated in FIG. 1B. In one such system, sensors 113 are placed on the trailer section 101 and a display 110 is mounted on the dashboard situated in the cab section 100. Since these two sections can separate, all electrical connections from the cab to the trailer have to be able to separate easily too.

In order to install a sensor/warning system several additional components are added to the trailer and cab sections which are not only difficult and expensive to install, but requires additional time to remove when the two sections need to be separated. Sensors 113 are mounted at appropriate locations on the trailer. The sensors are then hard wired individually to a rear control box 114 mounted under the chassis of the trailer. Each sensor needs its own conductive path 117 to the 7-pin junction box. Needless to say, if there are more sensors, there are more wires running to the 7-pin junction box.

The rear control box 114 receives signals from the sensors and sends them to a control box 111 in the cab section 100. Control box 111 and display 110 may be separate as shown in FIG. 1B, or may be combined as one single unit. The signals are sent from the sensors to control box 111 by mounting a bundle of conductors 112 from rear control box 114 to a 7-pin junction box 116 which exists on the front wall of the trailer. This 7-pin junction box 116 is mounted on the outside of the trailer on the side closest to the cab section. Another 7-pin junction box 115 exists on the outside of the cab on the rear side closest to the trailer section. This 7-pin junction box has new wires that run to the dashboard via the control box 111 where it displays the results of the sensors. The trailer conductor 112 is coupled to the cab via coiled bundle 118. Thus, with an aftermarket system, a long under-chassis conductor must be mounted on the trailer 101, with new 7-pin junction boxes 115 and 116 coupled by new coiled conductor 118. When the trailer and cab are hooked up or taken apart, more electrical hookups must now be handled than without the sensor/warning system.

An example of one type of sensor/warning system display is shown in FIG. 1C. The display system indicates levels of proximity to objects using a familiar traffic light display system. A red light means the vehicle is less than two feet away from an obstacle, a yellow light means the vehicle is between two and four feet away from an obstacle, and a green light means the vehicle is more than four feet away from an obstacle. In addition, unique audible tones may be provided and associated with each light to provide additional information about the proximity of objects.

Example Sensor/Warning Display

An example of the sensor/warning system is illustrated in FIGS. 2A and 2B. As seen in FIG. 2A, the display of the sensor results can take several different forms. At step 201 it is in the form of text. This text can be displayed on a small display screen, and an example of a textual message is seen at step 204 (i.e. “The rear is two feet away from an obstacle”). It can take the form of a graphical display, as seen at step 202. This display can be the outline of the vehicle with the locations of the sensors. Each sensor can have a light depending on its status, and an example is seen at step 205. It can also take the form of lights accompanied by appropriate sounds, as seen at step 203. For example, a red light accompanied by a constant high pitched beep can indicate a collision, and an example is seen at step 206.

Zones

Since large vehicles have sides that extend far behind the driver, it is extremely difficult for the driver to be able to see clearly past all the sides, especially during backing up and making turns. For this reason, the sensors can be placed evenly on all four sides. FIG. 2B shows at step 207 an example of dividing a vehicle into four sections or zones. Step 208 is the driver side, labeled zone 1. Step 209 is the rear side, labeled zone 2. Step 210 is the passenger side, labeled zone 3, and step 211 shows the front side, labeled zone 4.

A sensor/warning system is an important safety device that can save lives and property. However, in larger vehicles this system is too expensive and labor intensive to install. This results in this device not being used as much as possible.

The same problems described above with respect to sensor/safety systems are also true for other electronic devices and components. All electronic devices need power and need at least some level of controllability (on/off for example) and thus require some way of communicating control signals to the device or component. To date, there has been no satisfactory way to add electrical components to a vehicle without requiring extensive additional wiring.

### SUMMARY OF THE INVENTION

The invention provides a method and apparatus for using the power line carrier of vehicles as a data bus. The scope of this invention is not limited to vehicles, but can be implemented in other applications that either have a power source or are wired to one, and require data to be transmitted from one component to another.

In one embodiment, the invention uses the existing power line of a HDTTU (the power line runs from the battery, and is 12 volts in the case of vehicles) to transmit data. An electronic device can be separated into two components, a control unit near the driver, and a performance unit in the rear of the vehicle. Both units can tap into existing power lines for power requirements. In addition, using the present invention, the power line can be used to transmit control signals and other data between the units. This eliminates the need for a separate hard wired connection between the units, simplifying installation. The present invention accomplishes this by encoding control signals into power line modulations that can be detected and decoded. In this way, data can be transmitted between units using the power line.

For example, when the power line of a HDTTU is used to carry data pertaining to a sensor/warning system, this data is signals from sensors placed on the vehicle to a display panel on the dashboard. These sensors are coupled to a junction box which is used to convert the signals to a form that can be carried on the existing power line. An existing electrical coupling connects the power line from the trailer to the cab. In the cab, a second junction box is coupled to the power line and can detect signals placed on the power line by the sensor junction box. This system obviates the need for additional conductors from the trailer junction box to the cab, as well as for additional junction boxes and conductors between the cab and the trailer. This is because the present invention uses the existing power line as the carrier of data, and this existing power line, as seen earlier, runs from the front of the cab section to the rear of the trailer. Since the power line wiring is already factory installed, the present invention also eliminates the need for new wiring which as seen in prior art systems can create a maze of wires that are time consuming to disconnect when the cab and trailer sections need to be separated. This simplified sensor/warning system which uses existing power line wires as a carrier for data is easier to install and more likely to be used, increasing vehicle and highway safety.

### BRIEF DESCRIPTION OF THE DRAWINGS

These and other features, aspects and advantages of the present invention will become better understood with regard to the following description, appended claims and accompanying drawings where:

FIG. 1A is an illustration of existing wiring on a HDTTU.

FIG. 1B is an illustration of a prior art sensor/warning system on a HDTTU.

FIG. 1C is an illustration of a display panel.

FIG. 2A is an illustration that shows the different kinds of display panels.

FIG. 2B is an illustration that shows a vehicle divided into different zones.

FIG. 3 is an illustration of the control box.

FIG. 4 is an illustration of the present invention on a HDTTU.

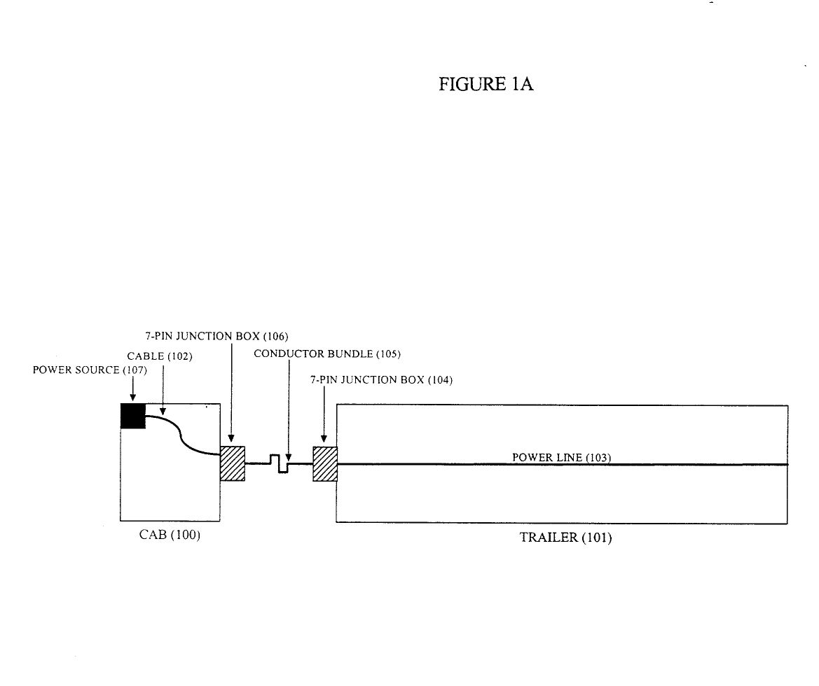

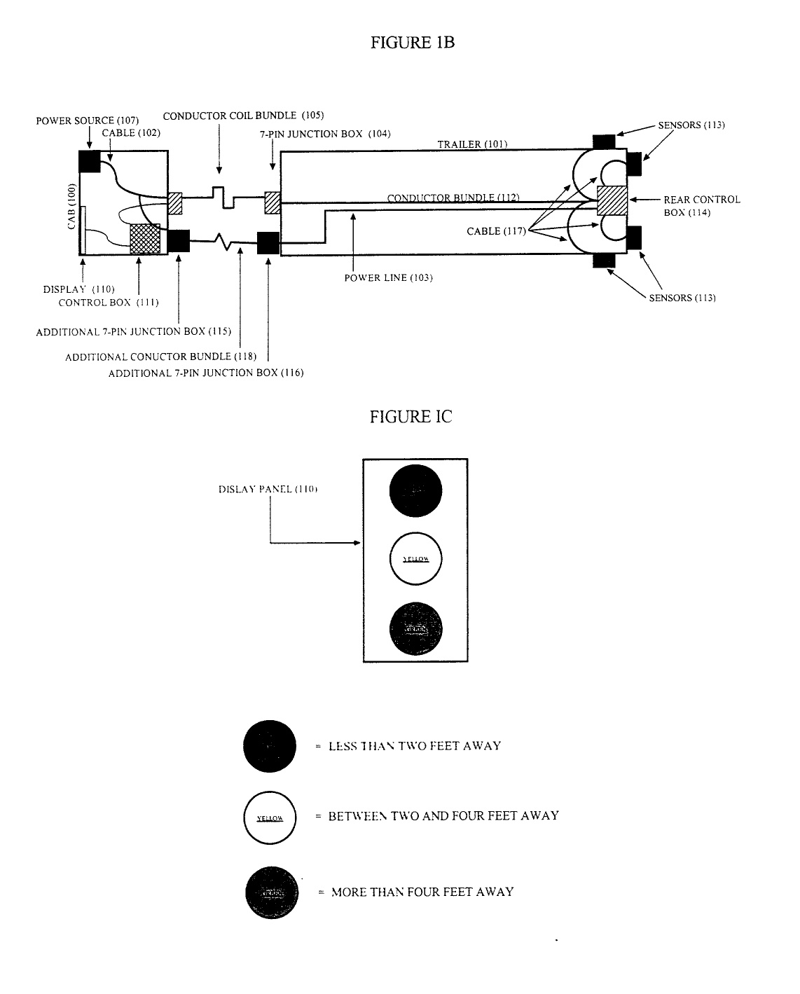

### DETAILED DESCRIPTION OF THE INVENTION

The invention is a method and apparatus for using the power line carrier of vehicles as a data bus. In the following description, numerous specific details are set forth to provide a more thorough description of embodiments of the invention. It is apparent, however, to one skilled in the art, that the invention may be practiced without these specific details. In other instances, well known features, like the electrical cabling in vehicles, have not been described in detail so as not to obscure the invention.

The present invention provides a method for providing detectable signals on a power line in a vehicle environment. The detectable signals can be used to generate binary words that code information. For example, if four distinct detectable signals can be provided on the power line carrier, a four bit binary word can be represented. This in turn can represent 16 states of information. Other embodiments of the invention can be provided that have other numbers of detectable signals on the power line, so that larger binary words can be defined and utilized. In other words, the invention can use the power line as an addressable multi-bit bus.

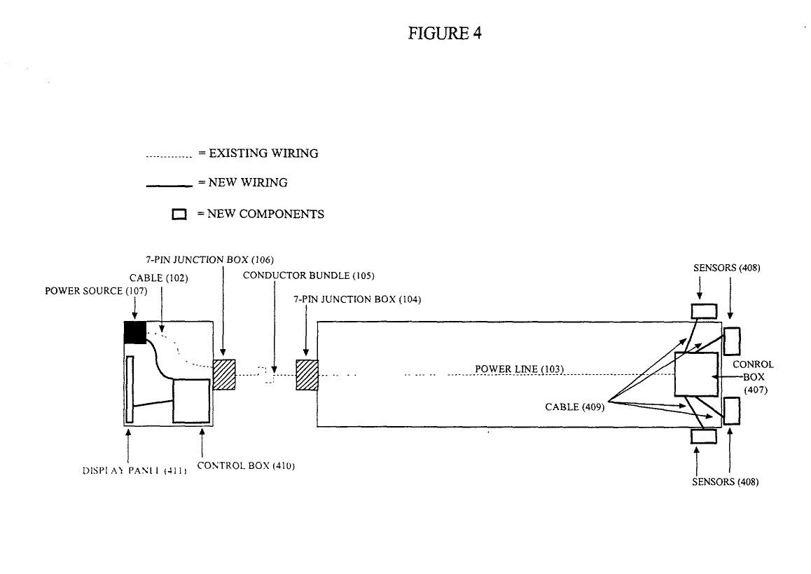

In one embodiment, the invention uses the existing power line of a HDTTU that runs from the front of the cab to the end of the trailer to transmit data. When used to transmit data from a safety device, like for example sensor signals from sensors attached to the trailer, the power line carries the signals from the sensors via a control box to a display panel in the cab. One embodiment of this invention is shown in FIG. 4 where sensor/warning data is transmitted from sensors placed on the trailer to a display panel in the cab. FIG. 4 shows a display panel 411 on the dashboard of the cab. This display panel is connected to control box 410 which taps into the existing power source 107. As noted earlier, the display panel 411 and control box 410 may be separate units as shown in FIG. 4, or may be combined into a single unit. Control box 410 encodes and decodes the signal from sensors 408 to the display panel. These sensors are wired separately 409 to a control box 407 at the rear of the trailer, and taps directly into the power line 103 that runs to the rear of the trailer. The conductive path of the sensor signals is along the existing path 105 from existing junction boxes 104 and 106. No additional junction boxes or coiled conductors are needed for the cab trailer coupling, and no new chassis cable wiring need be performed.

Error Signal

An important feature of a sensor/warning system is knowing when it might not be operating correctly. The driver needs to know when the system cannot be relied on. Therefore, an error condition must be indicated at the display when the system is malfunctioning. The invention uses a pulse signal termed a heartbeat as the error signal. This heartbeat signal is part of the signal which is encoded and decoded by the control box. The heartbeat signal is a non-error signal that is always given by control box 407 once it is activated, and only ceases when there is an error or malfunction in the system. This error signal can be displayed in various ways, depending on how accurate the user needs to know where the error is.

There can be just one error signal for the entire system. This means that the heartbeat signal travels through the entire system, and ceases to be present when an error occurs. On the other hand, since the vehicle can be divided into zones, there can be one error signal for each zone. One way of activating the heartbeat signal is by turning on the ignition of the HDTTU, which clears the sensor/warning system of prior signals. If the driver notices a malfunction in the system at this point, the driver can conclude that the malfunction may be due to a burnt bulb or other mechanical error.

Coding/Decoding Of Sensor Signals

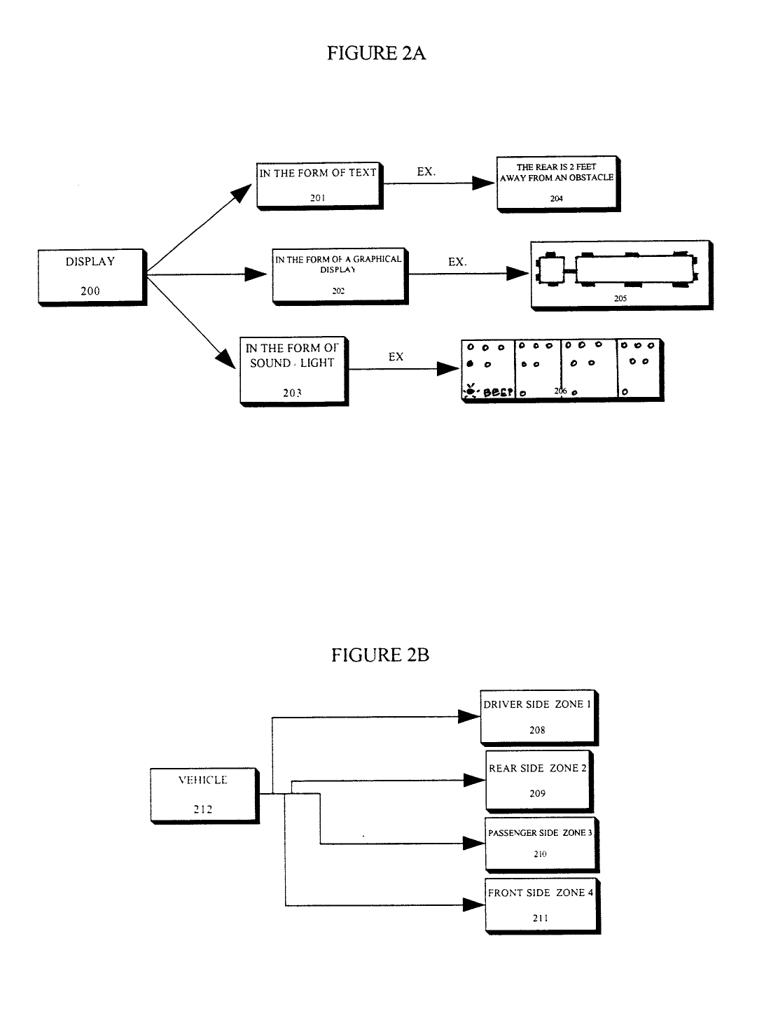

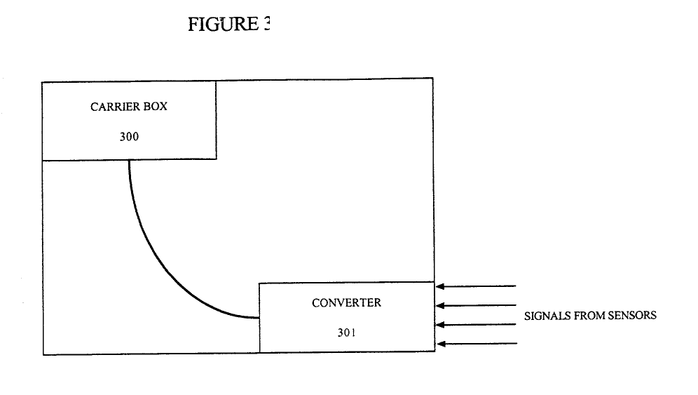

Control box 407 has two components in it, viz.: the converter and the carrier box, and these are illustrated in FIG. 3. Converter 301 gets the signals from the sensors via the power supply line. These signals are fed to carrier box 300 which decodes the signal and displays the results on the display panel. A carrier box that is capable of providing signals on the vehicle power line is manufactured by Air-Weigh, Inc. of Eugene, Oreg. As mentioned earlier, the display can take the form of text, lights, sound, or a combination of all three. If the trailer is divided into four sections as seen in FIG. 2B, and if each section has four sensors, then the three levels of collision detection (less than two feet, between two and four feet, and more than four feet), and a malfunction in the system for each side can be decoded, for example, as:

| Decoded Signal | Status |
|---|---|
| 0000 | Sensor # 1 is is error |
| 0001 | Sensor # 1 is less than 2 feet from obstacle |
| 0010 | Sensor # 1 is between 2 and 4 feet from obstacle |
| 0110 | Sensor # 1 is more than 4 feet from obstacle |
| 0100 | Sensor # 2 is in error |
| 0101 | Sensor # 2 is less than 2 feet from obstacle |
| 0110 | Sensor # 2 is between 2 and 4 feet from obstacle |
| 0111 | Sensor # 2 is more than 4 feet from obstacle |
| 1000 | Sensor # 3 is in error |
| 1001 | Sensor # 3 is less than 2 feet from obstacle |
| 1010 | Sensor # 3 is between 2 and 4 feet from obstacle |
| 1011 | Sensor # 3 is more than 4 feet from obstacle |
| 1100 | Sensor # 4 is in error |
| 1101 | Sensor # 4 is less than 2 feet from obstacle |
| 1110 | Sensor # 4 is between 2 and 4 feet from obstacle |
| 1111 | Sensor # 4 is more than 4 feet from obstacle |

The above table is for purposes of illustration of the example embodiment only. The invention is not limited to sensor data but is applicable to any type of data that is to be transmitted between electrical components. As noted previously, the invention is not to a four bit binary word but can be any number of bits depending on the number of uniquely detectable signals that can be provided on the power line.

A power line carrier standard (J2497) has been proposed for vehicles by SAE (Society of Automotive Engineers), and the present invention can take advantage of this standard for transmitting information via the power line.

Thus, a method and apparatus for using the power line carrier of vehicles as a data bus is described in conjunction with one or more specific embodiments. The invention is defined by the following claims and their fall scope of equivalents.

1. A method and apparatus for transmitting a signal on a vehicle comprising:
outputting first signal to a first control box;
converting said first signal to second signal;
coupling said second signal to a power line in said vehicle;
outputting said second signal to a second control box; and
converting said second signal to a third signal.

2. The method of claim 1 wherein said first signal is outputted from sensors.

3. The method of claim 1 wherein said third signal drives a display panel in said vehicle.

4. The method of claim 1 wherein said sensors detect the proximity of an object.

5. The method of claim 3 wherein said display panel further indicates an error signal.

6. The method of claim 5 wherein said error signal is a heartbeat signal.

7. The method of claim 1 wherein said step of coupling comprises tapping into the existing 12 volts power supply of said vehicle.

8. A method of transmitting data in a vehicle comprising:
coupling a first electronic component to an existing power line in said vehicle;
coupling a second electronic component to said existing power line;
generating detectable signals at said first component and transmitting said detectable signals on said power line;
detecting said signals at said second component and decoding said signals.

9. The method of claim 8 wherein said detectable signals are used to code binary data.

10. The method of claim 8 further including the sending of signals from said second component to said first component.
